(19) United States
(12) Patent Application Publication
(10) Pub. No.: US 2020/0189637 A1
(43) Pub. Date: Jun. 18, 2020

(54) FOLDABLE LOAD TRANSPORT CART

(71) Applicant: Hilti Aktiengesellschaft, Schaan (LI)

(72) Inventors: Kenth KARLSSON, Wasserburg (DE); Torsten PLATE, Hamburg (DE); Heiko TULLNEY, Aumuehle (DE)

(21) Appl. No.: 16/496,018

(22) PCT Filed: Jan. 29, 2018
(86) PCT No.: PCT/EP2018/052092

§ 371 Date: Sep. 20, 2019

(30) Foreign Application Priority Data
Mar. 24, 2017 (EP) 17162741.7

(51) Int. Cl. B62B 1/12; B62B 5/06

(52) U.S. Cl. CPC B62B 1/12; B62B 3/02; B62B 5/067

(57) ABSTRACT

A load transport cart for transporting loads includes a carrier frame, which has a first and a second carrier frame section, the first carrier frame section extending in a first extension plane, and the second carrier frame section extending in a second extension plane, at least two wheels being situated on the back side of the first carrier frame section for moving the load transport cart, and at least one first foldable tray, which is situated on the front side of the first carrier frame section, the load transport cart also including at least one second foldable tray, which is situated on the front side of the second carrier frame section, the second carrier frame section being pivotable, relative to the first carrier frame section, between a folded position and an unfolded position around an essentially horizontal carrier frame pivot axis situated between the first and second carrier frame sections.

The present invention relates to a load transport cart for transporting loads, preferably tool cases. The load transport cart includes a carrier frame, which has a front side and a back side and includes a first and a second carrier frame section. The first carrier frame section extends in a first extension plane, and the second carrier frame section extends in a second extension plane. At least two wheels are situated on the back side of the first carrier frame section for moving the load transport cart. At least one first tray is situated on the front side of the first carrier frame section.

### BACKGROUND

Load transport carts of the type mentioned at the outset are generally known from the prior art, for example in the form of dollies.

### SUMMARY OF THE INVENTION

It is an object of the present invention to provide a load transport cart of the type mentioned at the outset, which may be used in many different ways, is easy to handle and may be stored in a space-efficient manner.

In the case of a load transport cart of the type mentioned at the outset, the present invention provides that the load transport cart furthermore includes a second tray, which is situated on the front side of the second carrier frame section. The second carrier frame section is also pivotable, relative to the first carrier frame section, between a folded position and an unfolded position, around an essentially horizontal carrier frame pivot axis situated between the first and second carrier frame sections. In its unfolded position, the second carrier frame section is situated above the first carrier frame section in the direction of gravitational force. In the folded position of the second carrier frame section, the second extension plane of the second carrier frame section is situated essentially in parallel to the first extension plane of the first carrier frame section, and the back side of the second carrier frame section is situated opposite the back side of the first carrier frame section. The first and second trays are pivotable between a folded-up position and a folded-down position. In their folded-down position, the first and second trays are provided for the purpose of accommodating loads to be transported on their upward-facing sides. In its folded-up position, the first tray is situated essentially in parallel to the first extension plane of the first carrier frame section, and the second tray is situated essentially in parallel to the second extension plane of the second carrier frame section.

The present invention includes the finding that a wide variety of tools and devices are used, for example on construction sites, which are needed in different deployment areas and must thus be transported from one deployment area to another deployment area. Although conventional dollies are suitable for transporting loads, they are bulky and are difficult to transport, particularly on rough terrain, such as on construction sites.

The load transport cart according to the present invention may be folded up from its unfolded utility state to a compact size. The pivotable arrangement of the first and second carrier frame sections makes it possible to use the entire length of the carrier frame to attach trays. In the folded state, the load transport cart may be carried by an operator in the manner of a tool case. It is also possible to carry the folded load transport cart on one's back, like a backpack.

The first carrier frame section may include another, third tray on its front side, which is situated below the first tray in the direction of gravitational force. Like the first and second trays, the third tray is also pivotable between a folded-up position and a folded-down position. In its folded-up position, the third tray may be situated, relative to the first tray, in particular in such a way that the third tray at least partially abuts the first tray. In other words, the first and third trays may overlap in the direction of gravitational force in their folded-up position. In this way, it is further ensured that the load transport cart may be folded up to a compact size by attaching a third tray.

For this reason, it is also advantageous if a tray situated on the first or the second carrier frame section does not essentially protrude beyond the first or second carrier frame section in its folded-up position. For example, the trays may be situated on the carrier frame in such a way that they do not protrude by more than 10% of the length of the corresponding first or second carrier frame section (measured in the longitudinal direction thereof).

It is furthermore advantageous if the trays of the carrier frame are pivotable upwardly from the folded-down position into the folded-up position, i.e. against the direction of gravitational force. The upward-facing sides of the trays in the folded-down position (which are used as support surfaces) are then opposite the front side of the carrier frame in the folded-up position of the trays. This may simplify the construction of the bearing of the trays, compared to the downward pivotability, i.e. in the direction of gravitational force.

In one preferred specific embodiment, in its unfolded position, the second carrier frame section includes a fourth tray on its upper end in the direction of gravitational force. The fourth tray may also be pivotable between a folded-up position and a folded-down position. To be able to compactly fold up the load transport cart, the fourth tray is situated on the back side of the second carrier frame section in its folded-up state. If the fourth tray is to be folded down, it is pivoted onto the front side of the carrier frame. The pivot angle to be passed over is greater than 180°.

The load transport cart may be particularly flexibly used if its trays are pivotable between a folded-up position and a folded-down position independently of each other. In the unfolded state of the load transport cart, only one lower tray may be folded down for a large load occupying a great deal of space, while the other trays remain folded up. In the case of multiple smaller loads, however, all trays may be folded down and used for depositing the loads.

The trays may have, for example, a plate-shaped design including a flat contact surface for depositing a load. This is particularly advantageous for the first, second and third trays. In the case of the topmost tray of the carrier frame, in particular, i.e. the fourth tray, it has been proven that a design including support frames for suspending a load is favorable.

To reduce the folded size of the load transport cart, it is generally advantageous if the trays situated on the carrier frame define planes (like the first and second carrier frame sections), so that they may be preferably laid flat one on top of the other or stacked.

The wheels of the load transport cart may each be mounted on a wheel suspension in such a way that they are each rotatable around a wheel axis. The wheel suspensions are preferably pivotable between a folded-up position and a folded-down position around a wheel suspension axis situated perpendicularly to the carrier frame pivot axis. To ensure a compact folding of the load transport cart, it is preferred that the wheel axes of the wheels are each situated perpendicularly to the first extension plane of the first carrier frame section in the folded-up position of the wheel suspensions and in parallel to the first extension plane of the first carrier frame section in the folded-down position of the wheel suspensions. In this case, the wheel suspensions should also preferably have a compact design to minimize the width of the folded load transport cart (measured perpendicularly to the first extension plane of the first carrier frame section).

The wheel suspensions preferably each include a slide rail. The slide rails are intended to make it easier to negotiate stairs or other obstacles. For this purpose, the slide rails may run at a distance from the first carrier frame section and essentially in parallel to the longitudinal direction of the first carrier frame section. The distance between a slide rail and the first carrier frame section may approximately correspond to the distance between a point situated the farthest away from the first carrier frame section on the tire of one of the wheels and the first carrier frame section. However, the aforementioned spacing may also be slightly less than this distance and be at least 80% thereof.

It is again particularly advantageous if the slide rails are pivotable, together with the wheel suspensions, around the wheel suspension pivot axis between the folded-up position and the folded-down position of the wheel suspensions.

According to another preferred specific embodiment, the wheels each include an elastic tire and a plurality of spokes, the spokes being designed to cushion a deformation of the tire. In other words, the spokes may be formed in such a way that they supply an elastic support for the tire. In this case, the tire may be non-inflatable or non-pneumatic, since the spokes handle the cushioning. This design of the wheels is advantageous because it eliminates a laborious and time-consuming inflating of the tires. The load transport cart is always immediately ready for use. The wheels are preferably relatively large, because large wheels make it easier to move the load transport cart, compared to small wheels. For example, the wheels may have a diameter of 200 mm and a width of 60 mm (measured in the direction of the wheel axis).

To make it easier to carry the folded load transport cart, a grip arrangement may be situated on the downward-facing side of the first tray in the folded-down position in the direction of gravitational force in such a way that the operator may carry the transport cart by the grip arrangement in the folded state. The grip arrangement may be designed to be engaged from behind for better gripping thereof. The folded load transport cart may then be comfortably carried by the operator like a tool case.

If one or multiple tool cases are to be stowed on the load transport cart, it is advantageous if they may be secured on the trays with the aid of straps. For this purpose, the carrier frame may include first coupling means, which may be coupled with first mating coupling means of a strap to be attached to the load transport cart. In addition, the trays may include second coupling means, which may be coupled with second mating coupling means of a strap situated on the load transport cart. With respect to the folded-up positions of the trays, the second coupling means are preferably situated on the upper ends of the trays in the direction of gravitational force, in particular those of the first, second or third tray.

The present invention also relates to the use of the foldable load transport cart described above as a shelving system. For this purpose, it is provided to fasten the load transport cart to a wall with the aid of at least one adjustable fastening device situated on the wall.

Other advantages result from the following description of the figures. The figures illustrate different exemplary embodiments of the present invention. The figures, the description and the claims contain numerous features in combination. Those skilled in the art will advantageously also consider the features individually and combine them to form other meaningful combinations.

### BRIEF DESCRIPTION OF THE DRAWINGS

In the figures, identical and equivalent components are provided with identical reference numerals.

FIG. 1 shows a load transport cart according to the present invention in the unfolded utility state in a perspective front view at an angle from below;

FIG. 2 shows a front side view of a load transport cart according to the present invention in the unfolded state;

FIG. 3 shows a load transport cart according to the present invention in the folded utility state in a perspective front view at an angle from above;

FIGS. 4A through 4E show examples of a procedure for folding up a load transport cart according to the present invention from the unfolded utility state into the folded stated;

FIG. 5 shows a fully loaded load transport cart according to the present invention in the unfolded utility state in a perspective front view at an angle from below;

FIG. 6 shows a load transport cart according to the present invention, loaded with a tool case, in the unfolded utility state in a perspective front view at an angle from above;

FIG. 7 shows a load transport cart according to the present invention in the unfolded utility state in a perspective rear view at an angle from above;

FIG. 8 shows a wheel of a load transport cart according to the present invention; and

FIGS. 9A through 9B show the load transport cart according to the present invention in a state at a distance from a fastening device and in a state suspended by the fastening device for using the load transport cart according to the present invention as a shelving system.

### DETAILED DESCRIPTION

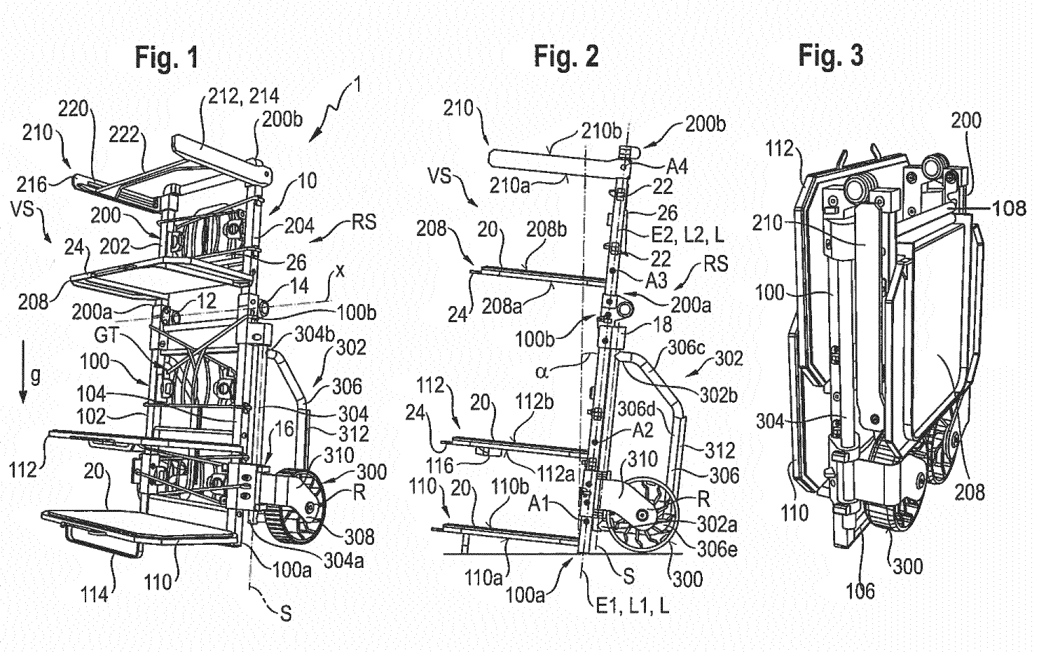

One preferred exemplary embodiment of a foldable load transport cart 1 is illustrated in FIGS. 1 through 3. FIGS. 1 and 2 show load transport cart 1 in its unfolded utility state, which is slightly tilted from a vertical position, while FIG. 3 shows the folded state of load transport cart 1. In the following, the direction indications “top,” “above” and “bottom,” “below” refer to direction of gravitational force g.

Load transport cart 1 includes a carrier frame 10. Carrier frame 10, in turn, includes a first carrier frame section 100 extending in a first extension plane E1 and a second carrier frame section 200 extending in a second extension plane E2. In addition, first carrier frame section 100 extends along a first longitudinal direction L1, and second carrier frame section 200 extends along a second longitudinal direction L2. First carrier frame section 100 has a lower end 100a and an upper end 100b. Second carrier frame section 200 likewise has a lower end 200a and an upper end 200b.

In the following, the unfolded utility state of load transport cart 1 defines a front side VS and a back side RS of carrier frame 10 or its first and second carrier frame sections 100, 200.

Two wheels 300, which are used to move load transport cart 1, are situated on back side RS of first carrier frame section 100. The design of wheels 300 of load transport cart 1 is described in detail below.

As is apparent from FIGS. 1 through 3, first carrier frame section 100 includes two parallel longitudinal struts 102, 104, which are connected to each other by a lower transverse strut 106 on lower end 100a of first carrier frame section 100 and an upper transverse strut 108 on upper end 100b of first carrier frame section 100. Second carrier frame section 200 similarly includes two parallel longitudinal struts 202, 204, which are connected to each other by an upper transverse strut 206 on upper end 200b of second carrier frame section 200.

First longitudinal strut 102 of first carrier frame section 100 is connected in an articulated manner to first longitudinal strut 202 of second carrier frame section 200 by a first articulated joint 12. Second longitudinal strut 104 of first carrier frame section 100 is correspondingly connected in an articulated manner to second longitudinal strut 202 of second carrier frame section 200 by a second articulated joint 14. In other words, lower end 200a of second carrier frame section 200 is coupled with upper end 100b of first carrier frame section 100 by the two articulated joints 12, 14. In the unfolded utility state of load transport cart 1, articulated joints 12, 14 define an essentially horizontal carrier frame pivot axis X between first and second carrier frame sections 100, 200. In this way, second carrier frame section 200 is pivotable, relative to first carrier frame section 100, between a folded position (FIG. 3) and an unfolded position (FIGS. 1 and 2) around carrier frame pivot axis X.

As is apparent in FIGS. 1 and 2, second carrier frame section 200 is situated above first carrier frame section 100 in its unfolded position. First and second extension planes E1, E2 of first and second carrier frame sections 100, 200 are essentially in parallel to each other. In the unfolded utility state of load transport cart 1, second carrier frame section 200 is in its unfolded position. In the unfolded utility state of load transport cart 1, first and second carrier frame sections 100, 200 also preferably extend along a common longitudinal direction L, so that first and second longitudinal directions L1, L2 are coaxial to each other.

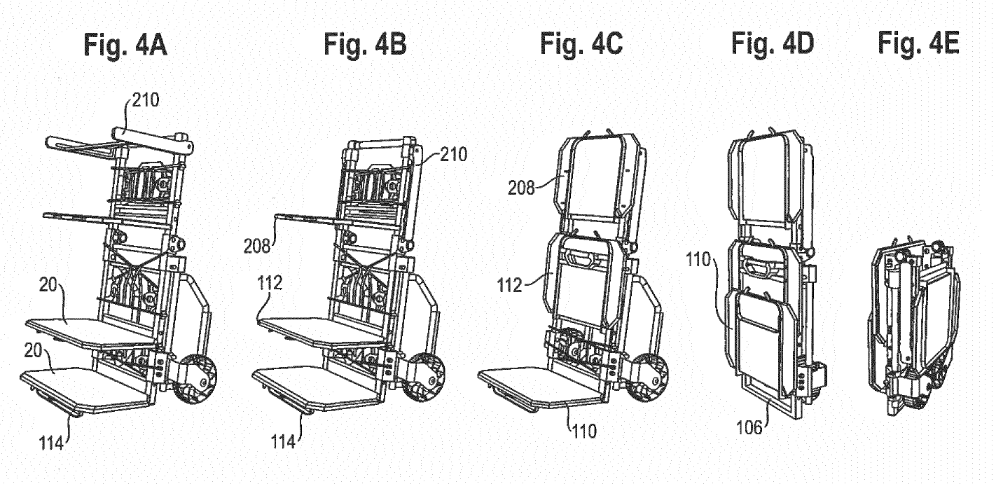

Two trays 110, 112 are situated on front side VS of first carrier frame section 100. Lower tray 110 of first carrier frame section 100 is situated near lower end 100a of first carrier frame section 100 and below upper tray 112 of first carrier frame section 100. Lower tray 110 is pivotable around a pivot axis A1 and upper tray 112 is pivotable around a pivot axis A2 between a folded-up position and a folded-down position (FIGS. 4A through 4E).

In addition to the two trays 110, 112 of first carrier frame section 100, second carrier frame section 200 also includes two trays 208, 210 on its front side VS. Upper tray 210 of second carrier frame section 200 is situated near upper end 200b of second carrier frame section 200 and above lower tray 208 of second carrier frame section 200. Lower tray 208 is pivotable around a pivot axis A3 and upper tray 210 is pivotable around a pivot axis A4 between a folded-up position and a folded-down position (FIGS. 4A through 4E).

In FIGS. 1 and 2, trays 110, 112, 208, 210 are shown in their folded-down position perpendicular to first and second extension planes E1, E2 of first and second carrier frame sections 100, 200. In their folded-down position, trays 110, 112, 208, 210 of carrier frame 10 or of first and section carrier frame sections 100, 200 each define a downward-facing underside 110a, 112a, 208a, 210a and an upward-facing upper side 110b, 112b, 208b, 210b.

To transfer the two trays 110, 112 of first carrier frame section 100 and lower tray 208 of second carrier frame section 200 from their folded-down position into the folded-up position, trays 110, 112, 208 are each pivoted upwardly, i.e. against direction of gravitational force g (clockwise in the illustrated exemplary embodiment), around pivot axis A1, A2, A3 assigned to particular tray 110, 112, 208. Locking means are provided to securely hold the two trays 110, 112 of first carrier frame section 100 and lower tray 208 of second carrier frame section 200 in the particular folded-up position. The pivoting movements of trays 110, 112, 208, 210 of carrier frame 10 are explained in greater detail below with reference to FIGS. 4A through 4E.

Load transport cart 1 also includes two wheel suspensions 302, which are provided with an essentially identical design. The design of only one of wheel suspensions 302 is therefore discussed below.

Wheel suspension 302 includes a first bar 304 extending in longitudinal direction L1 of first carrier frame section 100, which has an upper end 304b and a lower end 304a. First bar 304 is supported in a first pivot bearing 16 near its lower end 304a. Upper end 304b of bar 304 is supported in a second pivot bearing 18. A wheel suspension pivot axis S, which extends along bar 304 and around which wheel suspension 302 is pivotable, is defined by this arrangement.

Wheel suspension pivot axes S of the two wheel suspensions 302 are in parallel to each other and perpendicular to carrier frame pivot axis X and longitudinal direction L1 of first carrier frame section 100. Due to this pivotable bearing of the two wheel suspensions 302, the latter are pivotable, together with wheels 300, independently of each other between a folded-up position and a folded-down position.

A second bar 306 is formed on first bar 304 of wheel suspension 302. More specifically, second bar 306 is integrally connected to upper end 304b of first bar 304 on its upper end 306b and to lower end 304a of first bar 304 on its lower end 306a. First and second bars 304, 306 are situated in a shared extension plane. In the folded-up position of wheel suspensions 302, the extension plane spanned by first and second bars 304, 306 runs in parallel to extension plan E1 of first carrier frame section 100 (FIG. 3).

Second bar 306 has an upper bar section 306c, a middle bar section 306d and a lower bar section 306e. Upper bar section 306c may be used, for example, as a grip for an operator of load transport cart 1.

Middle bar section 306d runs at a distance in parallel to first bar 304. In the illustrated exemplary embodiment, a slide rail 312 is mounted on the side of middle bar section 306d facing away from back side RS of first carrier frame section 100. Second bar 306 and slide rail 312 provided thereon make it possible to easily negotiate steps or other obstacles, compared to the case that such a structure is not present.

Lower bar section 306e of second bar 306 is integrally connected to a first support arm 308 (FIG. 7) and the lower bar section of first bar 304 is integrally connected to a second support arm 310. Wheel 300 of wheel suspension 302 is supported between first and second support arms 308, 310 in such a way that wheel 300 is rotatable around a wheel axis R.

Wheel axes R are perpendicular to first extension plane E1, E2 of first carrier frame section 100 in the folded-up position of wheel suspensions 302 and in parallel to first extension plane E1 of first carrier frame section 100 in the folded-down position of wheel suspensions 302. The two wheel axes R are coaxial to each other in the folded-down position of wheel suspensions 302.

The procedure for folding up a load transport cart 1 according to the present invention is now described below on the basis of FIGS. 4A through 4E.

Load transport cart 1 illustrated in FIG. 4A essentially corresponds to that in FIGS. 1 and 2. Load transport cart 1 in FIG. 4A is in the unfolded utility state, all of its trays 110, 112, 208, 210 being folded down, i.e. are in their folded-down position.

In the unfolded utility state of load transport cart 1 illustrated in FIGS. 2 and 4A, longitudinal directions L1, L2 of the first and second carrier frame sections run essentially in parallel to each other and approximately in parallel to direction of gravitational force g. The deviation from the vertical orientation of load transport cart 1 is due to an elongated support device 114 situated on underside 110a of lower tray 110 of first carrier frame section 100. As is apparent in FIGS. 2 and 4A, load transport cart 1 is supported on support device 114 as well as on lower transverse bar 106 and lower ends of first and second longitudinal struts 102, 104 of first carrier frame section 100. Longitudinal directions L1, L2 enclose an angle of inclination a of approximately 6° with direction of gravitational force g. During use, load transport cart 1 may be tilted out of this unfolded utility state in FIGS. 2 and 4A by supporting it on wheels 300, so that angle of inclination a of approximately 6° is increased to a higher value. In FIGS. 2 and 4A, wheels 300 do not touch the ground but rather float at a slight distance above the ground. The floating arrangement of wheels 300 simplifies a tilting of load transport cart 1 out of the unfolded utility state. Lower transverse strut 106 may also be used for tilting purposes.

In FIG. 4B, upper tray 210 of second carrier frame section 200 was pivoted out of its folded-down position into its folded-up position. The pivot angle passed over during this pivoting movement is greater than 180°. Since upper tray 210 of second carrier frame section 200 is essentially perpendicular to extension plane E2 of second carrier frame section 200 in the folded-down position in FIG. 4B, the pivot angle executed by upper tray 210 between the illustrations in FIGS. 4A and 4B is essentially 270°. In FIG. 4B, upper tray 210 is situated on back side RS of second carrier frame section 200.

In FIG. 4C, lower tray 208 of second carrier frame section 200 and upper tray 112 of first carrier frame section 100 were moved from the folded-down position into the folded-up position. The pivot angle passed over during this upwardly directed pivoting movement is essentially 90°. In the folded-up position, upper side 112b of upper tray 112 of first carrier frame section 100 and upper side 208b of lower tray 208 of second carrier frame section 200 at least partially come to rest against front side VS of carrier frame 10. Upper tray 112 of first carrier frame section 100 and lower tray 208 of second carrier frame section 200 do not overlap each other in their folded-up positions.

In FIG. 4D, lower tray 110 of first carrier frame section 100 was also pivoted from its folded-down position into its folded-up position. As in the case of lower tray 208 of second carrier frame section 200 and upper tray 112 of first carrier frame section 100, lower tray 110 of first carrier frame section 100 is folded upwardly during this pivoting movement around a pivot angle of essentially 90°. Upper side 110b of lower tray 110 of first carrier frame section 100 abuts underside 112a of upper tray 112 of first carrier frame section 100 in its folded-up position; at least in this respect, lower and upper trays 110, 112 of first carrier frame section 100 overlap each other in longitudinal direction L1 of first carrier frame section 100. If trays 110, 112, 208, 210 are in their folded-up positions, as illustrated in FIG. 4D, they are essentially in parallel to first and second extension planes E1, E2 of first and second carrier frame sections 100, 200.

In FIG. 4D, the two wheel suspensions 302 were also pivoted around their particular wheel suspension pivot axis S out of the folded-down position into the folded-up position.

FIG. 4E shows the folded state of load transport cart 1. To reach the arrangement in FIG. 4E from the arrangement in FIG. 4D, second carrier frame section 200 is pivoted downwardly relative to first carrier frame section 100 around carrier frame pivot axis X. The pivot angle in this pivoting movement is essentially 180°.

As is apparent from FIG. 4E, back side RS of second carrier frame section 200 is opposite back side RS of first carrier frame section 100 in the folded position of second carrier frame section 200, so that second extension plane E2 of section carrier frame section 200 is situated essentially in parallel to first extension plane E1 of first carrier frame section 100.

Due to the described foldable arrangement of second carrier frame section 200 relative to first carrier frame section 100 as well as to their lower and upper trays 110, 208, 112, 210, it is possible to fold up load transport cart 1 to a compact and easy-to-handle size. This permits an easier transport and a space-saving stowing of load transport cart 1. For example folded load transport cart 1 itself may be carried by an operator with one hand, in the manner of a suitcase.

In the illustrated exemplary embodiment, in its unfolded utility state, load transport cart 1 has a total length of approximately 1110 mm (measured in longitudinal direction L1, L2), a width of approximately 693 mm (measured perpendicularly to extension planes E1, E2) and a breadth of approximately 664 mm (measured in the direction of carrier frame pivot axis X). In the folded state, load transport cart 1 has a length of approximately 725 mm (measured in longitudinal direction L1), a width of approximately 201 mm (measured perpendicularly to extension plane E1) and a breadth of approximately 520 mm (measured in the direction of carrier frame pivot axis X).

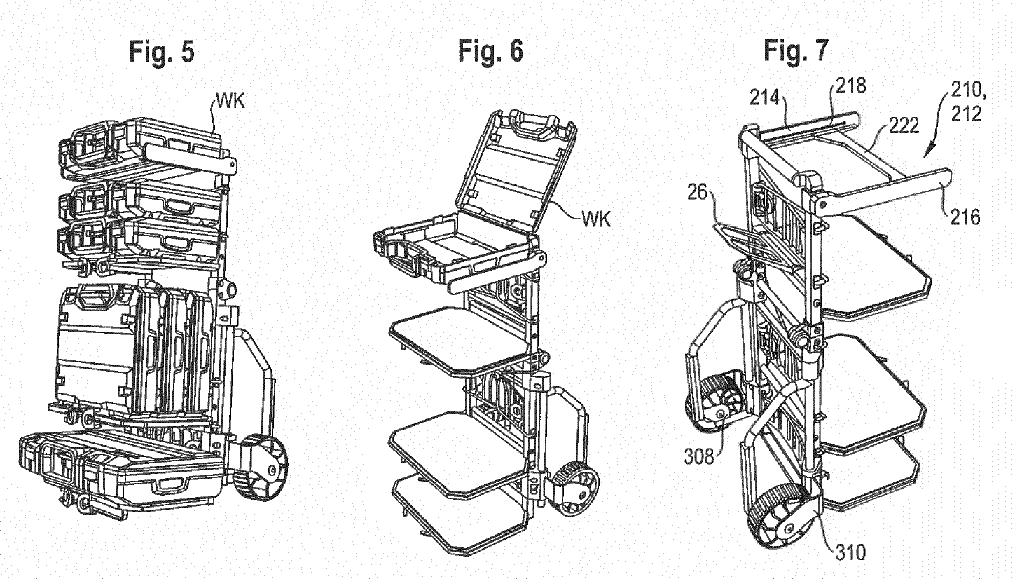

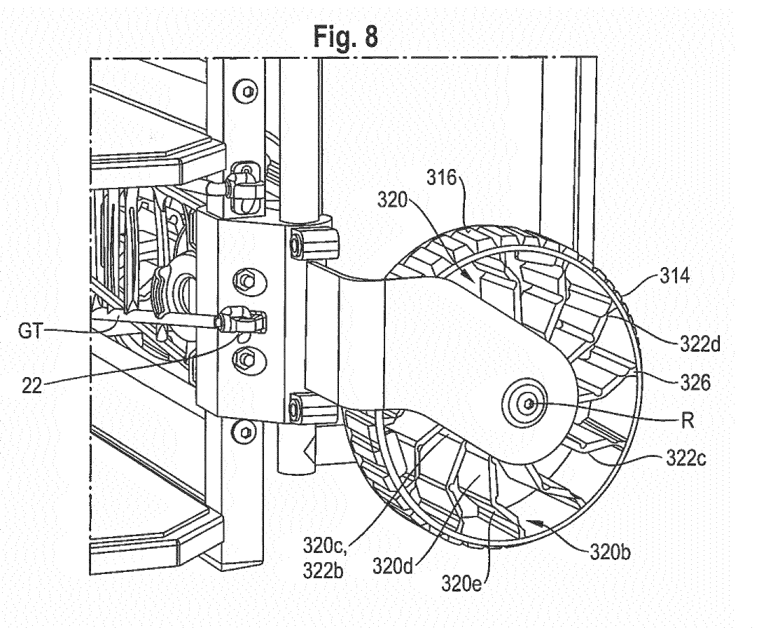

The foldable design of trays 110, 112, 208, 210 of carrier frame 10 facilitates a particularly flexible loading of load transport cart 1, for example with tool cases WK (FIG. 5). Depending on which of trays 110, 112, 208, 210 are folded down or folded up, larger or smaller tool cases WK or other loads may be transported on load transport cart 1. In the arrangement of trays 110, 112, 208, 210 illustrated in FIG. 4C, for example, load transport cart 1 may accommodate a particularly large load on bottom tray 110 of first carrier frame section 100.

Lower and upper trays 110, 112 of first carrier frame section 100 and lower tray 208 of second carrier frame section 200 are designed as flat plates. As illustrated in FIG. 5, tool cases WK, for example, may be placed on these three trays 110, 112, 208 stacked one on top of the other and standing next to each other. A slip-resistant covering 20 is attached to upper sides 110b, 112b, 208b of trays 110, 112, 208.

The width of the contact surfaces, i.e. the effectively usable surface of upper sides 110b, 112b of lower and upper trays 110, 112, is approximately 368 mm (measured perpendicularly to extension plane E1 in each case) and that of lower tray 208 is approximately 343 mm (measured perpendicularly to extension plane E2). The breadth of contact surfaces of trays 110, 112, 208 is approximately 520 mm (measured in the direction of carrier frame pivot axis X).

Straps GT may be used to fix toolbox WK on trays 110, 112, 208 (FIG. 1). To attach straps GT on carrier frame 10, first coupling means 22 are situated on first and second carrier frame sections 100, 200, which may be coupled with first mating coupling means provided on an end of a strap. Second coupling means 24 are provided on upper ends of trays 110, 112, 208 of carrier frame 10 in the folded-up position, which may be detachably connected to second mating coupling means on the other end of strap GT. Straps GT may be flexible (e.g. made from rubber) or inflexible (e.g. designed as tie-down straps).

Upper tray 210 of second carrier frame section 200 differs structurally from the other three trays 110, 112, 208 of carrier frame 10. Upper tray 210 of second carrier frame section 200 includes a support frame 212, which includes two guide rails 214, 216, which run in parallel to each other and are connected in an articulated manner to second carrier frame section 200. Support frame 212 also includes a transverse strut 222, which connects the two guide rails 214, 216 to each other on the underside 210a. A guide structure 218, 220 extending along the longitudinal direction of guide rails 214, 216 is provided on each of the opposite inner surfaces of the two guide rails 214, 216.

If a toolbox WK is provided with complementary mating engagement structures with respect to the two engagement structures 218, 220 of upper tray 210 of second carrier frame section 200, for example along its side surfaces, toolbox WK may be pushed onto folded-down upper tray 210 in a horizontal position (FIGS. 5 and 6). Toolbox WK is held by transverse strut 222 of upper tray 210 and by the engagement of engagement structures 218, 220 with the corresponding mating engagement structure. Straps, as described in connection with other trays 110, 112, 208, are not necessary in the case of upper tray 210 of second carrier frame section 200. Upper tray 210 thus permits toolbox WK to be readily opened or closed as needed (FIG. 6).

To make it easier to carry load transport cart 1 in its folded state, a grip arrangement 116 is provided on underside 112a of upper tray 112 of first carrier frame section 100. Grip arrangement 116 is situated in such a way that grip arrangement 116 is above upper end of lower tray 110 in the folded-up position of upper and lower trays 112, 110 of first carrier frame section 100. Grip arrangement 116 is also situated in such a way that it is just below carrier frame pivot axis X or essentially at the same height as upper transverse strut 108 of first carrier frame section 100 in the folded state of load transport cart 1. Grip arrangement 116 does not protrude beyond the upper end of upper tray 112 and is designed to engage from behind.

As is apparent in FIG. 7, a hook device 26 is situated on back side RS of second carrier frame section 200, which is movable between a folded-up position and a folded-down position. The folded-up position of hook device 26 is illustrated, for example, in FIG. 1. Hook device 26 may be used to hold cables, hoses or the like.

The construction of wheels 300 is described below, which may also represent an independent aspect of the present invention. Since wheels 300 are identical to each other, only one of wheels 300 is discussed below.

Wheel 300 includes a continuous, non-inflatable or non-pneumatic tire 314 and a hub 318, which are connected to each other by identical spokes 320 situated an equal distance apart. Tire 314 has a profiled tread 316. Tire 314, hub 318 and spokes 320 are designed to be integral with each other. Wheel 300 is formed, for example, from a polymer material. Spokes 320 are formed in such a way that they provide an elastic support. Each spoke 320 has an end 320a closer to hub 318 and an end 320b closer to tire 314 and extends along an extension surface in the longitudinal direction. The extension surface of a spoke 320 is not straight but is curved in a U shape or in an inverted U shape. More specifically, each spoke 320 has a section 320c closer to hub 318 in the longitudinal direction and a section 320e closer to tire 314 as well as a middle section 320d situated between these two sections 320c, 320e. Section 320c closer to hub 318 and section 320e closer to tire 314 have approximately the same length and are shorter than middle section 320d (measured in the longitudinal direction of spoke 320). A hinged joint 322b, 322c is formed between section 320c closer to hub 318 and middle section 320d as well as between section 320e closer to tire 314 and middle section 320d in that the cross-sectional surface of spoke 320 (measured perpendicularly to the extension surface of spoke 320) is smaller in the area of hinge joint 322b, 322c than outside this area. A hinge of this type is also referred to as a film hinge. In the connecting area between tire 314 and spoke 320 as well as between hub 318 and spoke 320, an elevation 324 facing spoke 320 on hub 318 or an elevation 328 on the tire is formed, to which spoke 320 is linked, again by a film hinge 322a, 322d.

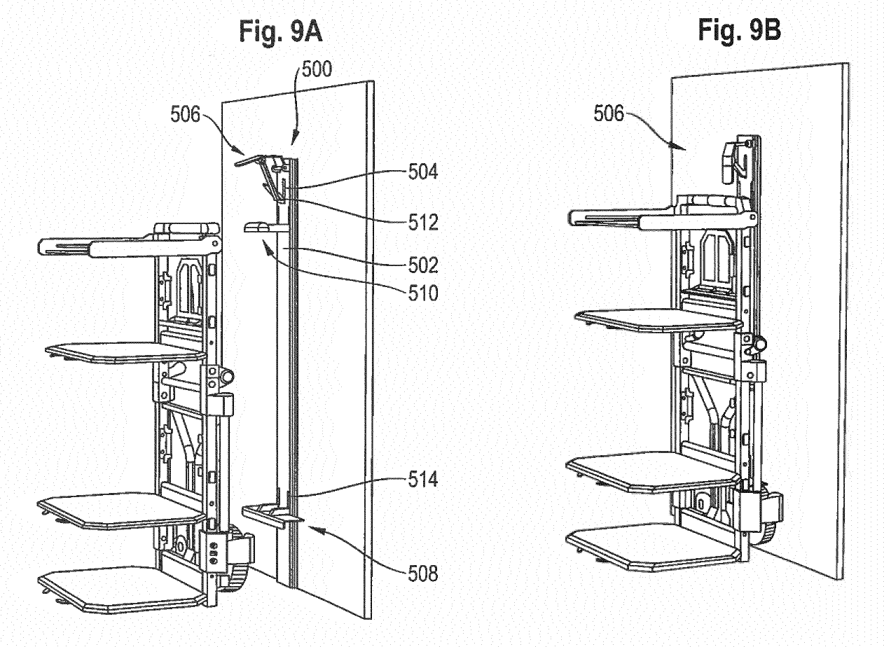

Unfolded load transport cart 1 is also suitable for use as a shelving system. As illustrated in FIGS. 9A and 9B, load transport cart 1 is held for this purpose in its unfolded utility state by a fastening device 500 fixed to a wall. Fastening device 500 includes a beam body 502, which has a guide channel 504 extending along beam body 502. A lever arrangement 506 situated on the upper end of beam body 502 is coupled with two holding brackets 508, 510 via connecting means 512 running in guide channel 504. One of holding brackets 508 is situated on the lower end of the beam body, while other holding bracket 510 is situated on the upper end of beam body 502 below lever arrangement 506. Holding brackets 508, 510 may be moved along beam body 502 in guide grooves 514 by actuating lever arrangement 506.

Lever arrangement 506 is movable between a loosened state (FIG. 9A) and a tightened state (FIG. 9B). By transferring lever arrangement 506 from the loosened state into the tightened state, holding brackets 508, 510 move downward along beam body 502. The downward movement of holding brackets 508, 510 enables a load transport cart 1 to be fixed on fastening device 500. In the illustrated exemplary embodiment, upper holding bracket 510 is configured to come into engagement with upper transverse bar 206 of second carrier frame section 200. Conversely, lower holding bracket 508 is configured to partially surround from above wheels 300 of wheel suspension 302 in its folded-up state.

### LIST OF REFERENCE NUMERALS

1 load transport cart
g direction of gravitational force
10 carrier frame
100 first carrier frame section
200 second carrier frame section
E1 first extension plane of the first carrier frame section
E2 second extension plane of the second carrier frame section
L1 first longitudinal direction of the first carrier frame section
L2 second longitudinal direction of the second carrier frame section
100b, 100a upper and lower ends of the first carrier frame section
200b, 200a upper and lower ends of the second carrier frame section
VS front side of the carrier frame
RS back side of the carrier frame
300 wheels
102, 104 first and second longitudinal struts of the first carrier frame section
202, 204 first and second longitudinal struts of the second carrier frame section
106, 108 upper and lower transverse struts of the first carrier frame section
206 upper transverse strut of the second carrier frame section
12, 14 first and second articulated joints
X carrier frame pivot axis
L shared longitudinal direction
110, 112 lower and upper trays of the first carrier frame section
208, 210 lower and upper trays of the second carrier frame section
A1, A2, A3, A4 pivot axes of the trays
110a, 112a, 208a, 210a undersides of the trays
110b, 112b, 208b, 210b upper sides of the trays
302 wheel suspensions
304, 306 first and second bars of the wheel suspension
304b, 304a upper and lower ends of the first bar
16, 18 first and second pivot bearings
S wheel suspension pivot axes
306b, 306a upper and lower ends of the second bar
308, 310 first and second support arms
306c, 306d, 306e upper, middle and lower bar sections of the second bar
312 slide rail
WK toolbox
20 slip-resistant covering
GT strap
22 first coupling means on the carrier frame
24 second coupling means on the trays
114 support device
α angle of inclination of the carrier frame
212 support frame
214, 216 guide rails
218, 220 engagement structures
222 transverse strut
116 grip arrangement
314 tire
316 tread
318 hub
320 spoke
322a, 322b, 322c, 322d hinge joint
320a the end of a spoke closer to the hub
320b the end of a spoke closer to the tire
320c, 320d, 320e spoke sections
324 elevation on the hub
326 elevation on the tire
26 hook device
500 fastening device
502 beam body
504 guide channel
506 lever arrangement
508, 510 lower and upper holding brackets
512 connecting means
514 guide grooves

What is claimed is:

1-14. (canceled)

15. A load transport cart for transporting loads, the load transport cart comprising:
a carrier frame having a front side and a back side and including a first and a second carrier frame section, the first carrier frame section extending in a first extension plane, and the second carrier frame section extending in a second extension plane;
at least two wheels for moving load transport cart situated on the back side of the first carrier frame section; and
at least one first tray situated on the front side of the first carrier frame section;
at least one second tray situated on the front side of the second carrier frame section;
the second carrier frame section being pivotable, relative to the first carrier frame section, between a folded position and an unfolded position, around a horizontal carrier frame pivot axis situated between the first and second carrier frame sections;
the second carrier frame section being situated above the first carrier frame section in the direction of gravitational force in its unfolded position, and, in the folded position of the second carrier frame section, the second extension plane of the second carrier frame section being situated parallel to the first extension plane of the first carrier frame section and the back side of the second carrier frame section being situated opposite the back side of the first carrier frame section;
the first and second trays being pivotable between a folded-up position and a folded-down position;
the first and second trays being provided in the folded-down position to accommodate loads to be transported on upward-facing sides; and
the first tray being situated parallel to the first extension plane of the first carrier frame section in the folded-up position, and the second tray being situated parallel to the second extension plane of the second carrier frame section in the folded-up position.

16. The load transport cart as recited in claim 15 wherein the first carrier frame section includes a third tray on the front side and situated below the first tray in the direction of gravitational force and pivotable between the folded-up position and the folded-down position, the first and third trays being situated in the folded-up position in such a way that the third tray at least partially abuts the first tray.

17. The load transport cart as recited in claim 15 wherein the first or second trays or a third tray are pivotable from the folded-down position into the folded-up position against the direction of gravitational force.

18. The load transport cart as recited in claim 15 wherein, in the unfolded position, the second carrier frame section includes a fourth tray on an upper end in the direction of gravitational force and pivotable between the folded-up position and the folded-down position, a passed-over pivot angle between the folded-down position and the folded-up position being greater than 180°.

19. The load transport cart as recited in claim 15 wherein the first or second trays, or a third or a fourth tray, are pivotable independently of each other between the folded-up position and the folded-down position.

20. The load transport cart as recited in claim 15 wherein the first or second trays or a third tray have a flat contact surface for depositing a load or a support frame for suspending a load.

21. The load transport cart as recited in claim 15 wherein the wheels are each rotatably supported on a wheel suspension around a wheel axis, the wheel suspensions each being pivotable around a wheel suspension pivot axis situated perpendicularly to the carrier frame pivot axis between the folded-up position and the folded-down position, the wheel axes of the wheels each being situated perpendicularly to the first extension plane of the first carrier frame section in the folded-up position of the wheel suspensions and parallel to the first extension plane of the first carrier frame section in the folded-down position of the wheel suspension.

22. The load transport cart as recited in claim 21 wherein the wheel suspensions each include a slide rail running at a distance from the first carrier frame section and parallel to the longitudinal direction of the first carrier frame section.

23. The load transport cart as recited in claim 22 wherein the slide rails are pivotable, together with the wheel suspensions, around the wheel suspension pivot axis between the folded-up position and the folded-down position of the wheel suspensions.

24. The load transport cart as recited in claim 15 wherein the wheels each include an elastic tire and a plurality of spokes, the spokes being designed to cushion a deformation of the tire.

25. The load transport cart as recited in claim 24 wherein the tire is a non-inflatable tire.

26. The load transport cart as recited in claim 15 further comprising a grip situated on the downward-facing side of the first tray in the folded-down position in the direction of gravitational force in such a way that the operator may carry the transport cart by the grip in the folded state.

27. The load transport cart as recited in claim 15 wherein the first and second carrier frame sections include first couplings coupleable with first mating couplings of a strap to be attached to a load transport cart.

28. The load transport cart as recited in claim 15 wherein, in the folded-up position, the first or second trays or a third tray include couplings on an upper end in the direction of gravitational force coupleable with second matings of a strap to be attached to the load transport cart.

29. A method of using the load transport cart load as recited in claim 15 comprising transporting a tool case as the load.

30. A method of using the load transport cart as recited in claim 15 as a shelving system, comprising
fastening the load transport cart to a wall with the aid of at least one adjustable fastening device situated on the wall.
